(19) United States
(12) Patent Application Publication
(10) Pub. No.: US 2026/0274372 A1
(43) Pub. Date: Sep. 17, 2026

(54) SMART IN-FRAME BICYCLE BACKBONE

(71) Applicant: 4iiii Innovations Inc., Cochrane (CA)

(72) Inventors: Jacob Pawluk, Cochrane (CA); Michael Mercer, Calgary (CA); Arthur Hare, Kitchener (CA); Dilan Tuff-Overes, Cochrane (CA); Philip White, Cochrane (CA)

(21) Appl. No.: 19/565,929

(22) Filed: Mar. 13, 2026

Related U.S. Application Data
(60) Provisional application No. 63/771,545, filed on Mar. 13, 2025.

(51) Int. Cl. B62K 19/30; B62J 43/28; B62J 43/30; B62J 45/41; B62J 50/22

(52) U.S. Cl. CPC B62K 19/30; B62J 43/28; B62J 43/30; B62J 45/41; B62J 50/22

(57) ABSTRACT

A smart in-frame bicycle backbone includes a control circuit disposed within a top tube of a bicycle frame, the control circuit including at least one processor, a memory storing instructions, and at least one antenna, a wiring bus routed within the bicycle frame and operatively coupled to the control circuit to distribute electrical power and data to electronic components of the bicycle, and an energy harvester mounted to the top tube and electrically coupled to the control circuit, wherein the control circuit is configured to (i) communicate with a smart device, (ii) provide power and data communication over the wiring bus to the electronic components, and (iii) execute one or more instructions to provide at least one of security monitoring, event detection, ride monitoring, maintenance prediction, or firmware management for the bicycle.

### CROSS-REFERENCE TO RELATED APPLICATIONS

This application benefits from and claims priority to U.S. Provisional Application No. 63,771,545, filed Mar. 13, 2025. The entirety of the aforementioned application is incorporated herein by reference.

### BACKGROUND

There are many high-end bicycle brands that produce high performance and expensive bicycle models. At this high level of performance, there are few significant differentiators between brands and models. While most focus on the performance of bicycle components such as the frame, brakes, tires, and derailleurs, none of these bicycles include smart technology. There are many after market products that a rider may add to their bicycle, but the added product has the appearance of an added aftermarket product and does not fully integrate with the bicycle. This lack of integration often increases weight and wind resistance and thereby reduces performance of the bicycle.

There are two main considerations when purchasing a high value bicycle: theft and safety. A high-performance bicycle left unattended presents an attractive opportunity for a thief, even when left outside a store for a short period. Since a rider may not want to carry a heavy chain and lock when out riding, the bicycle is likely to be left unlocked, and thus unprotected.

Riders of high-performance bicycles often go on long training rides and seek out remote areas to avoid vehicular traffic and frequent stop lights. The rider is often carrying minimal equipment to reduce weight. The combination of being alone and with minimal equipment raises a safety concern should the rider take a fall and become incapacitated, thus unable to raise the alarm and request help.

### SUMMARY

One aspect of the present embodiments includes the realization that high-performance bicycles do not include integral smart technology. The present embodiments solve this problem by providing a smart in-frame bicycle backbone. The bicycle backbone is a modular set of communicating components that are fully integrated with a frame of the bicycle and provide power and communication for other components of the bicycle, provide intelligence and processing capability to the bicycle itself, and further provide communication to and from the bicycle and remote services and/or devices.

Another aspect of the present embodiments includes the realization that a smart in-frame bicycle backbone may provide a security alarm that acts as a deterrent to a thief and may send a wireless alert to a remote device when unexpected movement of the bicycle is detected. For example, the bicycle backbone may generate a loud alarm sound when one or more motion sensors of the bicycle backbone detect unexpected movement of the bicycle. Further, the bicycle backbone may send an alert message to a rider’s smart phone or smart watch when the unexpected movement of the bicycle is detected.

Another aspect of the present embodiments includes the realization that a smart in-frame bicycle backbone may monitor activity of the bicycle and generate recommendations for predictive maintenance. For example, the bicycle backbone may monitor usage of the bicycle and recommend one or more maintenance activities based on the usage.

Another aspect of the present embodiments includes the realization that a smart in-frame bicycle backbone may detect wear of certain components of the bicycle and recommend replacement of the components as needed. For example, the bicycle backbone may include sensors capable of detecting wear of the chain and recommending replacement before a break occurs. In another example, the bicycle backbone may detect when a tire pressure is low and recommend adding more air. For example, when riding with a low tire pressure, there is an increased risk of a crash or that wheel damage may occur when riding over certain terrain. Therefore, an early warming of a low tire pressure may prevent injury or damage to the bicycle.

Another aspect of the present embodiments includes the realization that each after-market device added to a bicycle typically requires a proprietary interface and/or a proprietary app running on a smart phone for correct operation. Thus, a rider may need to switch between apps to view data from these different after-market devices. The present embodiments solve this problem by allowing a smart in-frame bicycle backbone to provide an interface with other devices included and/or added to the bicycle after purchase that collects and/or relays data from the devices to a remote service and/or remote device such as a single app running on the rider’s smart phone. For example, where the bicycle includes a power meter (e.g., implemented using sensors on cranks) the bicycle backbone collects the data from the power meter and sends it to a backbone app running on the rider’s smart phone. Where multiple devices are included or added to the bicycle, the bicycle backbone collects data from each device and relays it to the backbone app such that the rider does not need to switch between app the view the data.

Another aspect of the present embodiments includes the realization that a smart in-frame bicycle backbone may collect usage and performance data of the bicycle to allow a manufacturer of the bicycle to identify and implement improvements. A manufacturer of a bicycle does not typically get feedback from a rider or from the bicycle itself after the bicycle is sold and thereby does not learn how the bicycle is used and of any issues occurring. Through agreement with the rider, the bicycle backbone may send usage information such as duration and conditions and/or performance data such as input power levels and maintenance performed on the bicycle to the manufacturer, thereby allowing the manufacturer to identify areas for improvement and/or modification.

Another aspect of the present embodiments includes the realization that there is little to differentiate between high-end bicycle brands, which all have similar performance. The present embodiments solve this problem by providing a smart in-frame bicycle backbone that may be incorporated by a brand and thereby differentiating that brand over others.

### BRIEF DESCRIPTION OF THE FIGURES

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic diagram illustrating one example smart in-frame bicycle backbone, in embodiments.

FIG. 2 is a block diagram illustrating functionality of the control circuit of FIG. 1 in further example detail, in embodiments.

FIGS. 3A and 3B are images showing example integration of the control circuit, the energy harvester, and the antenna unit of FIG. 1 with the bicycle frame, in embodiments.

FIG. 4 shows the rear light of FIG. 3A in further example detail, in embodiments.

FIGS. 5A and 5B are isometric top and bottom views, respectively, of a circuit board implementation of the control circuit of FIG. 1, in embodiments.

FIG. 6 is an isometric view of the circuit board of FIG. 6 configured with a top cover that is sized and shaped to secure the circuit board within a recess of the top tube of the bicycle frame of FIG. 1, in embodiments.

### DETAILED DESCRIPTION OF THE EMBODIMENTS

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with scanners, safety laser scanners, computers, processors (hardware processors) memory or other storage have not been shown or described in detail to avoid unnecessarily obscuring descriptions of the various implementations and embodiments.

Unless the context requires otherwise, throughout the specification and claims which follow, the word “comprise” and variations thereof, such as, “comprises” and “comprising” are to be construed in an open, inclusive sense that is as “including, but not limited to.”

Reference throughout this specification to “one implementation” or “an implementation” or “one embodiment” or “an embodiment” means that a particular feature, structure or characteristic described in connection with the embodiment is included in at least one implementation or embodiment. Thus, the appearances of the phrases “one implementation” or “an implementation” or “in one embodiment” or “in an embodiment” in various places throughout this specification are not necessarily all referring to the same implementation or embodiment. Furthermore, the particular features, structures, or characteristics may be combined in any suitable manner in one or more implementations or one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

Exemplary embodiments will be described in detail herein, with examples thereof represented in the drawings. When the following descriptions involve the drawings, like numerals in different drawings represent like or similar elements unless otherwise indicated. Implementations described in the following exemplary embodiments do not represent all implementations consistent with the present disclosure. Instead, they are merely examples of apparatuses and methods consistent with some aspects of the present disclosure as detailed in the appended claims.

A key feature of a smart in-frame bicycle backbone is its integration with a frame of the bicycle. Design and manufacturing considerations of a bicycle frame typically include providing only the needed strength to support the wheels, crank, and handlebars of the bicycle. The present embodiments integrate a smart backbone within the bicycle frame.

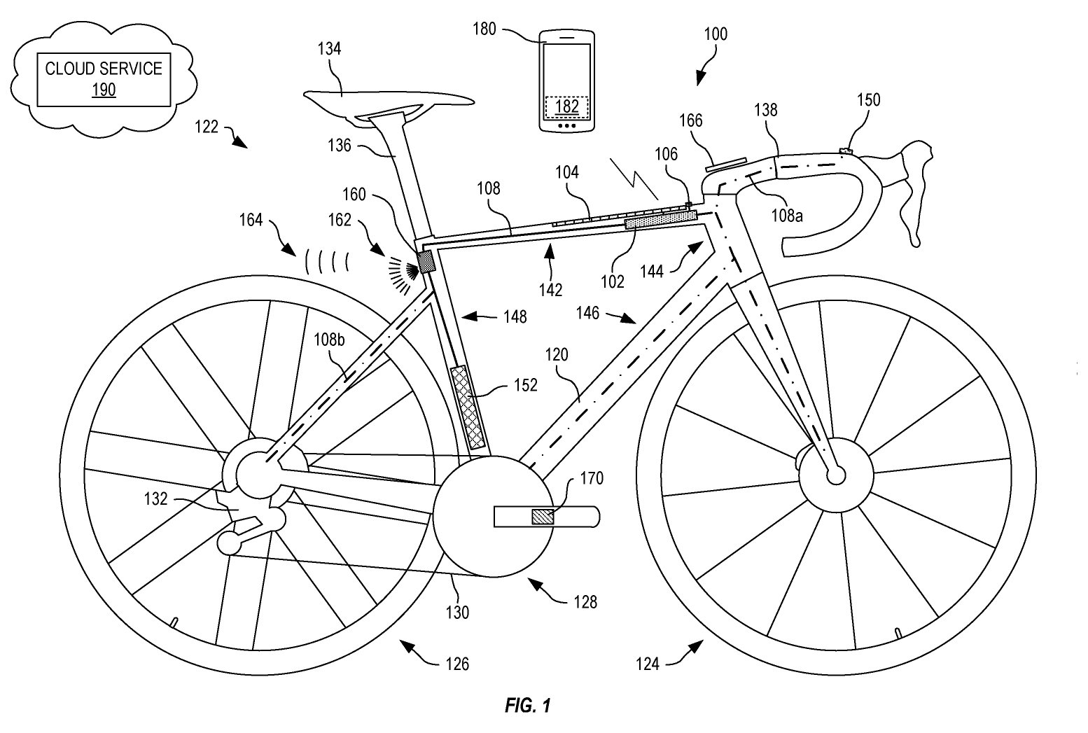

FIG. 1 is a schematic diagram illustrating a representative smart in-frame bicycle backbone 100, in embodiments. Bicycle backbone 100 includes a control circuit 102, an energy harvester 104, an antenna unit 106, and a wiring bus 108 that are fully enclosed with a bicycle frame 120.

Bicycle frame 120 is part of a bicycle 122 that also includes a front wheel 124, a back wheel 126, a crank 128, a chain 130, a derailleur 132, a seat 134, a seat stem 136, and a handlebar 138. Bicycle frame 120 is triangular and formed of a top tube 142 (also known as the crossbar), a head tube 144, a down tube 146, and a seat tube 148. Bicycle backbone 100 is fully integrated with bicycle frame 120 such that control circuit 102 is positioned within top tube 142, energy harvester 104 is a solar panel that is mounted at a top surface of top tube 142 and electrically connected to control circuit 102, antenna unit 106 is positioned at the top surface of top tube 142 and electrically connected to control circuit 102, and wiring bus 108 is routed within top tube 142 and seat tube 148. Optionally, wiring bus 108 extends through other parts of bicycle frame 120, indicated as optional wiring buses 108a and 108b. Wiring bus 108 may be implemented using one or more protocols including CAN bus, UART/Serial, I2C, and proprietary wired protocols defined by a manufacturer of bicycle frame 120 and/or bicycle 122. Wiring bus 108 may include one or more connectors (e.g., a standard connector type) and implement a standard communication protocol, such that wiring bus 108 may connect to other components of bicycle 122 to provide one or both of electrical power and communication. Bicycle backbone 100 is the heart of intelligence and control for bicycle 122, managing data and controlling power. Bicycle backbone 100 provides power distribution, control, and data communication for electronic components and devices of bicycle 122.

In certain embodiments, control circuit 102 includes a rechargeable battery that is charged by energy harvester 104 and may power control circuit 102 and other components connected to wiring bus 108. In other embodiments, bicycle backbone 100 includes a rechargeable battery 152 positioned within seat tube 148, for example. Energy harvester 104 may provide power to recharge rechargeable battery 152 via wiring bus 108. Where rechargeable battery 152 is included, the rechargeable battery of control circuit 102 may be omitted, or the two rechargeable batteries may be used together. A charging port may also be provided on bicycle frame 120.

In the example of FIG. 1, derailleur 132 is electronic and controlled by a switch 150 mounted to handlebar 138 where derailleur 132 is powered from rechargeable battery 152. Certain models of derailleur 132 may also include an energy harvester and may be configured to also provide an additional charge current to charge rechargeable battery 152. Advantageously, bicycle backbone 100 provides a power and communication solution over wiring bus 108 that is built into bicycle frame 120 and thereby removes the need for additional externally mounted batteries and wires. That is, other electrical components of bicycle 122, either built-in or added after purchase, may couple with wiring bus 108 to receive electrical power and external communication capability. Thus, these components do not need their own power sources (e.g., batteries) or wireless communication capability, since power and external communication is provided by bicycle backbone 100.

In one example, as shown in FIG. 1, bicycle 122 is fitted with a rear light 160 positioned at a top end of seat tube 148 to face rearwardly. Rear light 160 may be built into bicycle frame 120 or mounted externally. Rear light 160 connects (e.g., using a standard connector) with wiring bus 108 to receive power from rechargeable battery 152 and may receive a control signal from control circuit 102 that controls generation of light 162. As known in the art, rear light 160 may also include a radar unit that may be controlled (e.g., from control circuit 102 via wiring bus 108) to emit a radar signal 164 and detect a radar return from an object behind bicycle 122. Rear light 160 may determine an approach speed of the detected object to bicycle 122 and a direction of the object relative to bicycle 122. Rear light 160 may send the detected speed and location of the object to a head unit 168 (e.g., cycle computer, smart device 180 running app 182, etc.) mounted to handlebar 138 via wiring bus 108 and control circuit 102. Control circuit 102 may be configured to generate a warning signal (e.g., output to a smart device 180 of the rider or to a display and/or speaker mounted to bicycle 122) indicating the proximity of the object.

In another example, bicycle 122 includes a power meter 170 (e.g., configured with a crank shaft of crank 128) that wirelessly communicates with control circuit 102 via antenna unit 106. For example, power meter 170 is paired with control circuit 102 via a short-range wireless protocol such as Bluetooth™. However, control circuit 102 and power meter 170 may use other protocols without departing from the scope hereof. Power meter 170 may send, at intervals, one or more of instantaneous power, average power, and cadence metrics. Control circuit 102 receives the data from power meter 170 and may relay that data to smart device 180 of the rider and/or a cloud service 190.

Smart device 180 may be one of a smart phone, a smart watch, a smart display, and so on. Smart device 180 may run an app 182 (e.g., a smart phone application) that controls smart device 180 to communicate wirelessly, via one or more of a short-range wireless protocol such as Bluetooth™, Wi-Fi™, etc., with control circuit 102. App 182 is a bike-specific app that is created to handle all data related to operation and control of bicycle 122 as described in further detail below. For example, app 182 may receive data from one or both rear light 160 and power meter 170 via control circuit 102, and may receive data generated by control circuit 102.

Advantageously, bicycle backbone 100 is modular, making integration of bicycle backbone 100 into different configurations of bicycle 122 relatively simple. Further, this modularity makes bicycle backbone 100 expansive in that it is easily adaptive to accommodate additional devices and components that are added to bicycle 122. Bicycle backbone 100 also provides intelligent adaptable communication between electronic components and devices of bicycle 122 as well as between external services (e.g., cloud service 190) and devices (e.g., smart device 180 and app 182, and other networks). The locations of bicycle backbone components as shown in FIG. 1 are for purposes of illustrating principles disclosed herein and other locations may be used.

Control circuit 102 automatically selects the appropriate communication path based on the urgency of the message and external devices in wireless range. For example, where smart device 180 is within Bluetooth range, control circuit 102 selects the Bluetooth protocol for communication with smart device 180, and may use smart device 180 to relay communications between control circuit 102 and cloud service 190. Where control circuit 102 is able to connect with a Wi-Fi network (e.g., within wireless range and having access), control circuit 102 may communicate with smart device 180 and/or cloud service 190 via the Wi-Fi network. Where communication is not possible using Bluetooth or Wi-Fi, control circuit 102 may use a cellular network (or satellite network) to send and receive messages. Where communication is not urgent, control circuit 102 may buffer data (e.g., stored in memory) until a Wi-Fi connection is possible, such as when bicycle 122 arrives at a Wi-Fi hot spot, a home or an office location, at which time control circuit 102 sends the buffered data over the Wi-Fi network. Where smart device 180 is within Bluetooth range, control circuit 102 may send data to smart device 180 for storage.

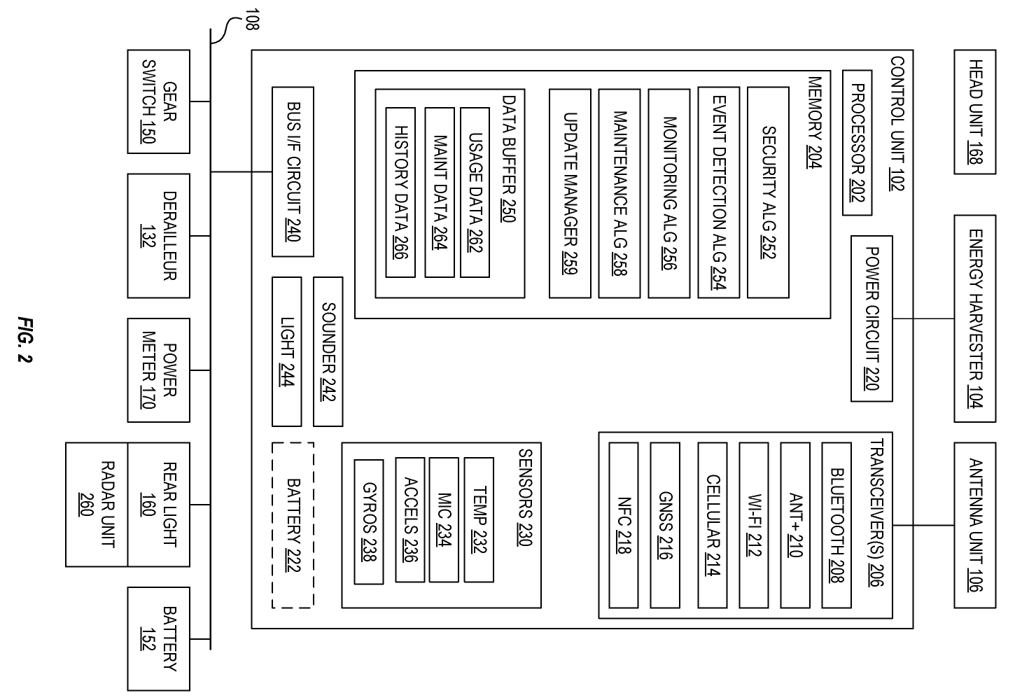

In another example, control circuit 102 may include a GNSS receiver (e.g., see transceivers 206 and GNSS protocol 216 of FIG. 2) for determining a current location and/or speed of bicycle 122. However, when control circuit 102 is connected to smart device 180 via Bluetooth, control circuit 102 may use locationing information from smart device 180 instead is using its internal GNSS, thereby saving power.

A further advantage of bicycle backbone 100 being built into bicycle 122 is that it also provides a direct link with a customer (e.g., the owner of bicycle 122), since bicycle backbone 100 communicates with the rider via smart device 180 and app 182 and is also in communication with cloud service 190, thereby providing a more consistent link between cloud service 190 (and any third party user thereof) and the rider.

FIG. 2 is a block diagram illustrating functionality of control circuit 102 in further example detail, in embodiments. Control circuit 102 includes at least one processor 202 and memory 204 storing machine-readable instructions that are executable by processor 202 to control operation of control circuit 102 as described herein.

Control circuit 102 includes one or more transceivers 206 that are electrically coupled with antenna unit 106 to cooperate to transmit and receive data, such as with smart device 180 and/or cloud service 190. Transceivers 206 may implement one or more of a Bluetooth protocol 208, an ANT+ protocol 210, a Wi-Fi protocol 212, a cellular protocol 214 (and/or satellite protocol), a GNSS protocol 216, and an NFC protocol 218.

Control circuit 102 may include a power circuit 220 that receives power from energy harvester 104, conditions the power for use by components of 102, and/or conditions the power for charging an internal battery 222 and/or rechargeable battery 152. In certain embodiments, internal battery 222 is omitted.

Control circuit 102 may include a plurality of sensors 230 such as one or more of a temperature sensor 232 and a microphone 234. Sensors 230 may also include motion sensors such as at least one accelerometer 236 (e.g., a tri-axis accelerometer) and at least one gyroscope 238 (e.g., a tri-axis gyroscope). Sensors 230 may be used to monitor a status of bicycle 122 as described in further detail below.

Control circuit 102 also includes a bus interface circuit 240 that controls operation of wiring bus 108 and may implement at least one protocol, such as CAN bus, UART/Serial, I2C, and proprietary wired protocols defined by a manufacturer of bicycle frame 120 and/or bicycle 122. Bus interface circuit 240 may also detect when new devices are connected to wiring bus 108 and/or when wiring bus 108 is damaged. Control circuit 102 may also include a speaker 242 and/or a light 244 that may be used to attract the attention of a person near to bicycle 122. For example, speaker 242 may be actuated to generate a siren sound and light 244 may be controlled to emit a strong strobing light.

Memory 204 may store at least one data buffer 250 that may be used to store data received via one or more of transceivers 206, sensors 230, and devices connected with wiring bus 108. Memory 204 is also shown storing a security algorithm 252, an event detection algorithm 254, a monitoring algorithm 256, a maintenance algorithm 258, and an update manager 259 that are each implemented as machine-readable instructions that, when executed by processor 202, perform the following functions.

Security algorithm 252, when enabled via app 182, causes processor 202 to monitor outputs of sensors 230 to detect unexpected movement of bicycle 122, whereby bicycle backbone 100 operates as an anti-theft alarm. For example, a rider uses app 182 to enable security algorithm 252 when leaving bicycle 122 unattended for a short period, such as outside a store. For example, security algorithm 252 may monitor output of at least one accelerometer 236 and/or at least one gyroscope 238 to detect when bicycle 122 is moved, by comparing outputs of at least one accelerometer 236 and/or at least one gyroscope 238 against one or more predefined thresholds, where signals greater than the predefined thresholds are interpreted to indicate that bicycle 122 is being unexpectedly moved. When security algorithm 252 determines that bicycle 122 is being unexpected moved, security algorithm 252 controls one or both of speaker 242 and light 244 to attract attention and controls transceivers 206 to transmit an alert message to one or more of smart device 180 and cloud service 190. For example, when smart device 180 is in wireless Bluetooth range or ANT+ range of control circuit 102, security algorithm 252 controls transceivers 206 to use Bluetooth protocol 208 or ANT+ protocol 210 to notify smart device 180 and/or app 182 of the possible theft of bicycle 122. When smart device 180 is not in Bluetooth range or ANT+ range of control circuit 102, security algorithm 252 controls transceivers 206 to use cellular protocol 214 to send an SMS to smart device 180. Advantageously, control circuit 102 alerts the rider of the unexpected movement of bicycle 122 irrespective of whether the rider is near bicycle 122.

In certain embodiments, security algorithm 252 may automatically disable itself when transceivers 206 detect proximity of an authenticated smart device 180 using NFC protocol 218. For example, as the rider approaches bicycle 122 and presents smart device 180 within NFC range of control circuit 102, transceivers 206 use NFC protocol 218 to detect smart device 180 and security algorithm 252 is automatically disabled. Similarly, security algorithm 252 may be automatically enabled when bicycle 122 is stationary and smart device 180 is not detected using NFC protocol. Advantageously, bicycle 122 is automatically protected by security algorithm 252 and the rider does not have to open an app or press buttons to activate and deactivate it.

In certain embodiments, bicycle backbone 100 may also operate as a location tracking tag (e.g., one or both of an Apple® AirTag® and an Android® Find®) that is able to provide a unique ID to a tracking network. Accordingly, bicycle backbone 100 may provide a current location of bicycle 122 via existing tracking networks, should bicycle 122 be stolen. Advantageously, since control circuit 102 is built into bicycle frame 120, it cannot be easily removed to prevent tracking. Further, since control circuit 102 is built into bicycle frame 120, tampering and disabling control circuit 102 is not easy or obvious.

In certain embodiments, security algorithm 252 implements one or more actions when unauthorized movement of bicycle 122 occurs. In one example, security algorithm 252 controls derailleur 132 to shift into a gear that makes pedaling of crank 128 difficult. In another example, security algorithm 252 controls derailleur 132 to continually shift between gears, again making pedaling of crank 128 difficult. In certain embodiments, bicycle 122 may include an electronically activated locking mechanism that may be controlled to lock certain components of bicycle 122 to prevent theft. For example, a servo operated locking mechanism may be engaged by security algorithm 252 to precent crank 128 from turning. Advantageously, security algorithm 252 may prevent an opportunist thief from riding away on bicycle 122.

In certain embodiments, bicycle backbone 100 may also connect with a smart home hub (e.g., SmartThings®, Matter® , etc.) when within wireless range of the hub. Advantageously, the smart hub may monitor presence of bicycle 122 when stored at home and provide an alert should bicycle backbone 100become disconnected from the hub.

In certain embodiments, bicycle backbone 100 may function as a cellular IoT device and connect to a cellular IoT network, such that attempted theft may be reported through the cellular IoT network.

Event detection algorithm 254 is enabled when bicycle 122 is in use and operates to detect any unexpected event, such as a crash when the rider falls off bicycle 122. For example, event detection algorithm 254 may cause processor 202 to monitor outputs of one or more of microphone 234, accelerometer 236, and gyroscope 238 to detect unexpected behavior of bicycle 122 based on combinations of rapid angle changes, sudden decelerations, and loud noises indicated by microphone 234, accelerometer 236, and gyroscope 238. For example, bicycle 122 may exhibit a sudden roll and strong acceleration when the rider falls or is knocked off of bicycle 122. When the event is detected, event detection algorithm 254 may first send a notification to smart device 180 and/or app 182 via transceivers 206 using Bluetooth protocol 208 and/or ANT+ protocol 210 requesting a response from the rider. When there is no response from the rider after a predefined period (e.g., twenty seconds), event detection algorithm 254 sends a message indicating the event, a current time, and a current location of bicycle 122 to cloud service 190, which may be configured to send messages to at least one registered device to alert an emergency contact person of the event. For example, cloud service 190 may send an SMS message to the registered device to inform the person of a time of the event and a location of the event. Advantageously, a third party may also be informed of the accident, such that help may be sent to assist the rider.

Monitoring algorithm 256 is enabled when bicycle 122 is being ridden and captures usage data 262 that includes evidence of how bicycle 122 is being used. At a minimum, usage data 262 defines a time measurement indicative of accumulated time of use of bicycle 122, where a ride duration is added to the time measurement. However, monitoring algorithm 256 is configurable to accumulate additional information. For example, a manufacturer of bicycle 122 may wish to learn details of how bicycle 122 is being used by its customers, since such information may lead to improvements in their products.

For example, monitoring algorithm 256 may process sensor data from one or more sensors 230 to determine additional details of each ride. For example, monitoring algorithm 256 may process data from temperature sensor 232 to determine environmental conditions and/or may retrieve environmental conditions from a weather service based on a location and time of the ride. In another example, monitoring algorithm 256 may process data from accelerometers 236 to classify a surface on which bicycle 122 is riding. In another example, monitoring algorithm 256 may process data from gyroscopes 238 to determine a portion of the ride duration that the rider was off the seat based on detected frame swing. In another example, monitoring algorithm 256 processes data from power meter 170 to determine one or more of an average and maximum power level generated by the rider and an average cadence of the rider.

Monitoring algorithm 256 may send usage data 262 to cloud service 190 (e.g., either directly or via smart device 180) such that it may be made available to a manufacturer and/or a designer of bicycle 122, where the data may be used by the manufacturer to provide a better service to the rider (e.g., customer) and/or improve the product. In certain embodiments, usage data 262 may be anonymized prior to being shared with a third party.

In certain embodiments, monitoring algorithm 256 may also determine usage data 262 while bicycle 122 is not being ridden. For example, monitoring algorithm 256 may track the location and environmental conditions of bicycle 122 while it is being stored and/or transported. Advantageously, usage data 262 may also provide useful history and theft profile information for the bike industry, that allows an insurer to adjust premium costs based on estimated risk determined from usage data 262.

Monitoring algorithm 256 may be configurable by cloud service 190 based on requests from third parties that use usage data 262. For example, a manufacturer of bicycle 122 may be aware of a potential problem and seek additional information on the potential cause. Advantageously, monitoring algorithm 256 may be configured by cloud service 190 to capture certain data from any of sensors 230 and other devices connected to wiring bus 108 that may inform the third party. Monitoring algorithm 256 may also collect data wirelessly from external devices, such as heart-rate monitors, hydration monitors, lactate monitors, etc. For example, a heart-rate monitor (e.g., chest strap or smart watch) may be paired with bicycle backbone 100 such that monitoring algorithm 256 may receive heart-rate data. Monitoring algorithm 256 may then send this data to other devices (e.g., head unit 168, smart device 180, cloud service 190, etc.) for use by other monitoring algorithms.

Modularity of bicycle backbone 100 facilitates capture of this data, since cloud service 190 is aware of active components of each bicycle backbone 100 and may thereby configure monitoring algorithm 256 to capture usage data 262 on when appropriate.

Maintenance algorithm 258 is enabled when bicycle 122 is being ridden and collects maintenance data 264 that may be used to determine when preventative maintenance would benefit bicycle 122. Maintenance algorithm 258 includes algorithms that may predict maintenance based on data from one or more sensors 230 and other devices connected to wiring bus 108. In certain embodiments, maintenance algorithm 258 may include an embedded neural network that is trained to identify wear of chain 130 or other components of bicycle 122 based on changes in sounds detected by microphone 234. For example, as chain 130 wears, it may start skipping gears under certain conditions and thereby make different sounds. By training the neural network to detect and categorize these sounds, maintenance algorithm 258 may detect the wear of chain 130 and provide a maintenance warning to check the claim. Advantageously, forewarned the rider may replace the chain before it breaks during a ride. Similarly, the tires make a certain noise when riding over different surfaces. However, where once tire starts making a slightly different noise, it may indicate a low pressure. This change in tire noise may be categorized by maintenance algorithm 258 as indicating a low tire pressure.

In another example, maintenance algorithm 258 monitors data from accelerometers 236 to characterize the surface bicycle 122 is riding on and automatically adjusts a maintenance schedule based on whether the surface is smooth or rough. For example, the more that bicycle 122 is used on round ground, the more frequent the need for preventative maintenance checks on bicycle 122.

In another example, maintenance algorithm 258 processes data from gyroscopes 238 and power meter 170 to determine the effort being expended by the rider of bicycle 122 and adjusts the preventative maintenance schedule based on the effort and its duration. For example, maintenance algorithm 258 decreases the maintenance interval when the data indicates that the rider is spending more time out of the seat and that the input power to crank 128 is high.

Since bicycle backbone 100 stays with bicycle 122 throughout its lifetime, monitoring algorithm 256, maintenance algorithm 258, and/or cloud service 190 may accumulate a history of use and maintenance of bicycle 122 that may be useful to a subsequent user of bicycle 122 when it is traded. This information (e.g., a maintenance profile and a usage profile) thereby forms a history of bicycle 122 that may be used to define its current state and/or its current value. Such profiles may be of significant value where bicycle 122 is a performance and/or high value product. Such profiles are previously unknown for bicycles.

In certain embodiments, maintenance algorithm 258 reports detected maintenance issues to cloud service 190, which in turn may send the data to a manufacturer of the relevant component. This in turn may allow the manufacturer to reach out to the rider with reminders and/or coupons for purchasing replacement parts. When this is combined with the usage data 262 generated by monitoring algorithm 256, the manufacturer learns more about the use and life of their product that may lead to improvement of the product.

Update manager 259 performs firmware updates of control circuit 102 and/or any electronic component or device connected to wiring bus 108. Update manager 259 may receive a firmware update for a specific component of bicycle 122 from cloud service 190. Update manager 259 may then send the update to the component at an appropriate time (e.g., when the device is not in use). In certain embodiments, update manager 259 may interrogate electronic components and devices connected to wiring bus 108 to determine current firmware levels and report these electronic components and device with their firmware levels to cloud service 190. Cloud service 190 may interact with respective manufacturers to retrieve any needed firmware updates. Cloud service 190 may also retrieve a firmware update from the manufacturer, and send the update to bicycle backbone 100 of bicycle 122 having that component. Advantageously, firmware updates are centrally managed by update manager 259 and cloud service 190 such that individual manufacturers do not need to include such management within each component. In certain embodiments, update manager 259 may connect with the electronic component or device to provide the firmware update wirelessly. Where operation of the electronic components or devices are based on subscriptions, update manager 259 and/or cloud service 190 may also manage those subscriptions and enable and/or disable functionality of the electronic component or device accordingly. This central management is also a benefit for the rider, since they no longer need to access different manufacturer or use different apps and accounts to manage firmware updates and subscriptions. For example, app 182 may communicate with cloud service 190 to allow management of firmware updates and subscription in one place.

Event detection algorithm 254, monitoring algorithm 256, maintenance algorithm 258, and update manager 259 may cooperate to generate history data 266 that provides a history of usage, events, maintenance, and firmware updates of bicycle 122. History data 266 thereby functions as a digital passport of bicycle 122 that remains with bicycle 122 throughout its life and may be useful to prospective resale purchasers. For example, history data 266 may indicate that bicycle 122 has been involved in a serious crash, or may indicate that bicycle 122 has only been ridden on smooth road surfaces. History data 266 may remain stored in non-volatile memory of control circuit 102 and/or uploaded to cloud service 190.

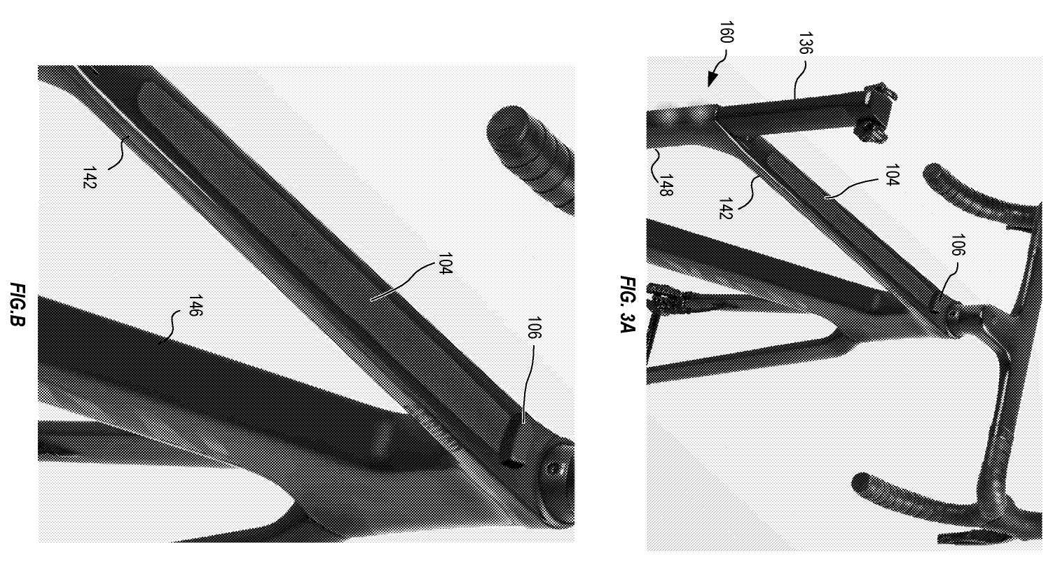

FIGS. 3A and 3B are images showing example integration of control circuit 102, energy harvester 104, and antenna unit 106 with bicycle frame 120, in embodiments. In embodiments, bicycle frame 120 may be assembled from welded tubes of steel, aluminum, or carbon fiber. Alternatively, bicycle frame 120 may be molded in a single piece using a monocoque molding process. Internal brackets may be provided inside bicycle frame 120 for receiving various components described herein. Bicycle frame 120 may also be designed with openings for receiving various components.

In embodiments, energy harvester 104 is a solar panel specifically designed for use with bicycle frame 120. In one example, energy harvester 104 is a PowerFoyle™ solar collector that is sized and shaped to fit within a recess of top tube 142. In this example, the PowerFoyle solar collector has a surface of 72cm² and produces 34mA in direct sunlight. Advantageously, the PowerFoyle solar collector does not look like conventional poly crystalline solar cells and may be pigmented to have a color similar to top tube 142 such that it is aesthetically pleasing.

Antenna unit 106 may include one or several antennas to provide the functionality as described above. Example antennas designed to be integrated on a printed circuit board will be described, but other antennas may be used without departing from the principles disclosed herein. Example antennas may include Virtual Antenna® components from Ignion: one NN02-224 RUN mXTEND™ antenna for LTE, and two NN03-320 DUO mXTEND™ antennas dedicated to GNSS and Bluetooth. The NN02-224 covers LTE low bands (791–960 MHz) and high bands (1710–2200 MHz). In embodiments, this antenna set provides solid multi-band support for LTE connectivity, GNSS location, and Bluetooth communication within the constraints of the PCB size.

As described above, control circuit 102 may relay data from sensors 230 to cloud service 190 (e.g., via smart device 180) in real time where it may be stored and/or monitored in real-time by a cycling team coach using an app connected with cloud service 190, for example. This real-time data may allow the coach to compare performance of multiple riders and thereby recommend position changes etc. In another example, bicycle backbone 100 and cloud service 190 may provide the real-time data to a broadcasting company that is following a cycle race such that certain data may be displayed on screen during the broadcast.

In certain embodiments, control circuit 102 includes an imager (e.g., a camera) positioned to capture infrared images of a face of the rider, whereby the images from the camera are processed to determine one or more of a stress level, a heart rate, a blood pressure, etc.

In certain embodiments, bicycle backbone 100 may also operate as a data recorder, where data output by sensors 230 and other connected electronic components is recorded within data buffer 250 during a ride and offloaded at the end of the ride to pone or both of cloud service 190 and/or 180. For example, at the end of a ride, when bicycle backbone 100 connects with a Wi-Fi network, monitoring algorithm 256 may upload the recorded data for further processing.

### Modularity

As described above, bicycle backbone 100 is modular and components may be added as needed. This allows bicycle backbone 100 to be used at all levels of a bicycle manufacturers range of products. For example, for a low-end product, bicycle backbone 100 may include control circuit 102, energy harvester 104, antenna unit 106, and internal battery 222. For a high-end product, bicycle backbone 100 may include bicycle backbone 100 may include control circuit 102, energy harvester 104, antenna unit 106, wiring bus 108, and rechargeable battery 152, where wiring bus 108 couples with multiple other electronic components and devices of the bicycle. Functionality of control circuit 102 may also be controlled through a subscription service, where the functionality (e.g., performance monitoring, maintenance monitoring, etc.) is enabled (e.g., over-the-air by cloud service 190) only when the rider purchases a corresponding subscription.

In one example, where a rider purchases and adds an antilock brake to bicycle 122, bicycle backbone 100 may auto-detect the added electronic component and automatically register it with cloud service 190, whereby cloud service 190 could register the product with the manufacturer on behalf of the rider. Further, bicycle backbone 100 is then configured to receive data from the added electronic component and process it for maintenance and/or usage purposes as described above.

### Implementation Examples

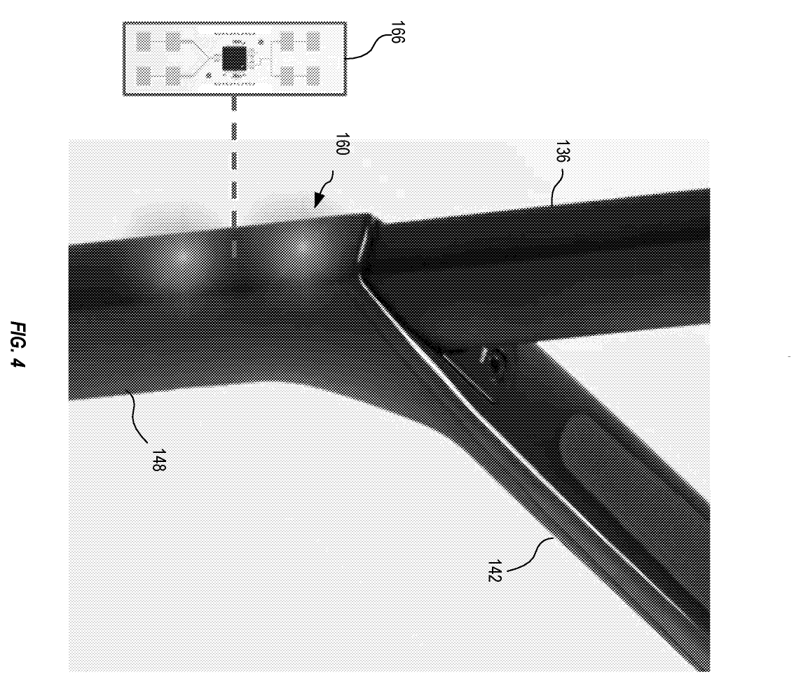

FIG. 4 shows one example of rear light 160 of FIG. 3A in further example detail as it is integrated with bicycle frame 120. Rear light 160 may include circuitry 166 that is placed inside seat tube 148 and connects to wiring bus 108 within bicycle frame 120 so there is no external wiring harness or need for a separate battery. Further, operation of rear light 160 may be controlled by control circuit 102 (e.g., via wiring bus 108) by using app 182 on smart device 180. Thus, rear light 160 does not have external switches. This allows a wide variety of settings to be used, such as randomized colors and patterns for noticeability, and automatic shutoff. The built-in radar unit 260 also connects with control circuit 102 via wiring bus 108 and has no external wiring, switches, or battery. As described above, built-in radar unit 260 may connect with head unit 168 to display warnings (e.g., visibly and/or audibly) of approaching objects (e.g., other vehicles).

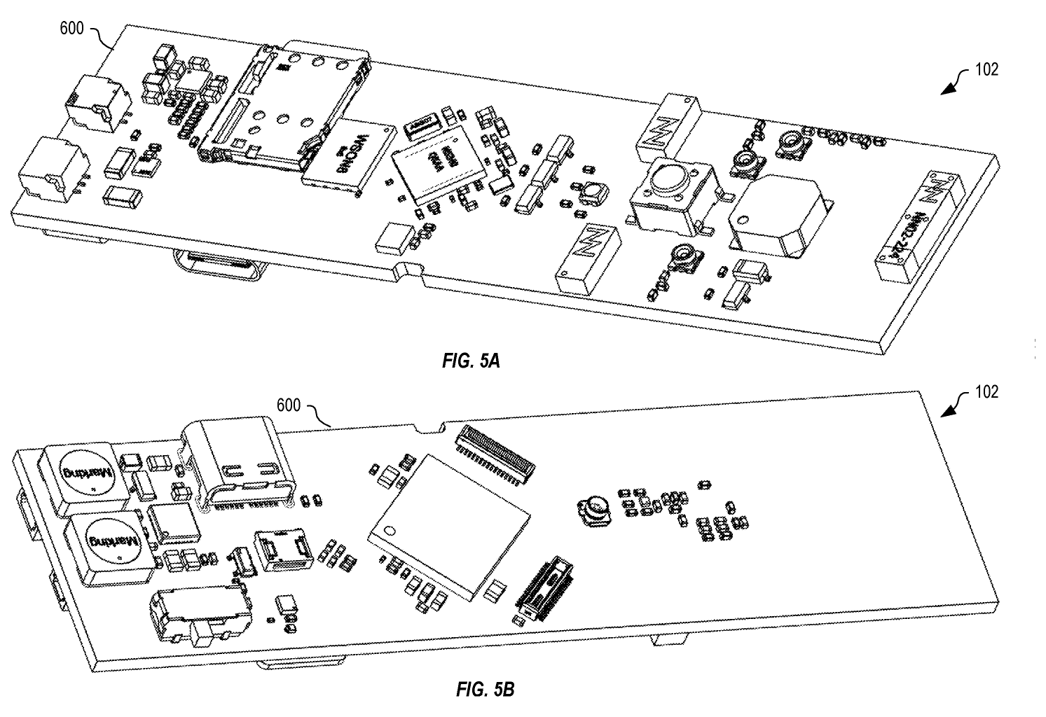

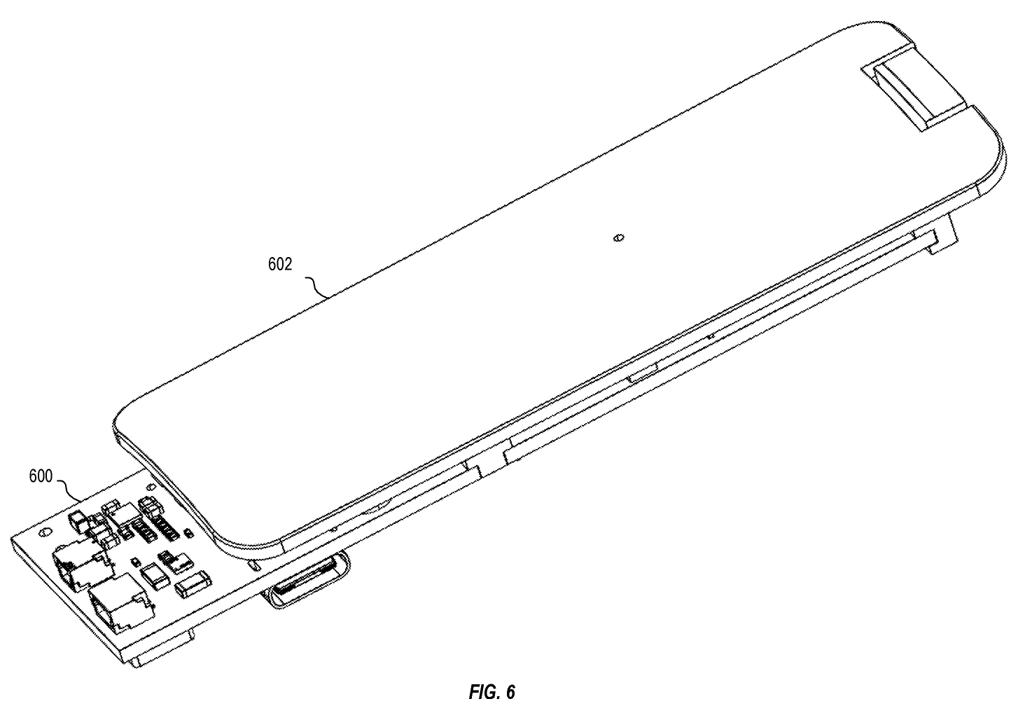

FIGS. 5A and 5B are isometric top and bottom views, respectively, of a representative circuit board 600 implementation of control circuit 102 of FIG. 1, in embodiments. FIG. 6 is an isometric view of circuit board 600 of FIG. 1 configured with a top cover 602. FIGS. 5A, 5B and 6 are best viewed together in the following discussion.

Circuit board 600 is shown with a variety of components, but embodiments discussed herein are not limited to the arrangement of components shown. Any arrangement of components may be used to meet the wiring and control functions described above.

Circuit board 600 may be sized and shaped for insertion into bicycle frame 120. Although a generally rectangular circuit board 600 is shown in FIGS. 5A and 5B, other shapes are contemplated. Circuit board 600, rechargeable battery 152 and wiring bus 108 may be inserted through openings in the frame that will later receive other components such as seat stem 136. They may also be inserted through dedicated openings into a cavity inside bicycle frame 120. For example, circuit board 600 may be attached to a back side of cover 602 which includes energy harvester 104. Cover 602 may snap or lock into a top surface of top tube 142. Other brackets and structures may be included on either of both of circuit board 600 and cover 602 to securely retain circuit board 600 within bicycle frame 120.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A smart in-frame bicycle backbone, comprising:
a control circuit disposed within a top tube of a bicycle frame, the control circuit including at least one processor, a memory storing instructions, and at least one antenna;
a wiring bus routed within the bicycle frame and operatively coupled to the control circuit to distribute electrical power and data to electronic components of the bicycle; and
an energy harvester mounted to the top tube and electrically coupled to the control circuit,
wherein the control circuit is configured to (i) communicate with a smart device, (ii) provide power and data communication over the wiring bus to the electronic components, and (iii) execute one or more instructions to provide at least one of security monitoring, event detection, ride monitoring, maintenance prediction, or firmware management for the bicycle.

2. The smart in-frame bicycle backbone of claim 1, further comprising a rechargeable battery disposed within the frame and chargeable by one or both of the energy harvester or an external charging port.

3. The smart in-frame bicycle backbone of claim 1, wherein the energy harvester comprises a solar collector sized to fit a recess in the top tube and to charge a rechargeable battery within the frame.

4. The smart in-frame bicycle backbone of claim 1, the at least one antenna is coupled to an antenna unit integrated with the top tube and comprising antennas dedicated to cellular and short-range wireless communication.

5. The smart in-frame bicycle backbone of claim 1, wherein the control circuit further comprises motion sensors and a speaker, and security monitoring includes monitoring signals from the motion sensors to detect unauthorized movement, actuating the speaker, and transmitting an alert to the smart device.

6. The smart in-frame bicycle backbone of claim 5, wherein NFC proximity of an authenticated smart device automatically disables the security monitoring and loss of NFC proximity automatically enables the security monitoring.

7. The smart in-frame bicycle backbone of claim 5, wherein the event detection includes detecting a crash based on signals from the motion sensors indicating rapid angle change and sudden deceleration, and notifying an emergency contact with a time and location.

8. The smart in-frame bicycle backbone of claim 1, wherein the ride monitoring generates usage data collected by the electronic components and sensors in the control circuit including ride duration, environmental conditions, surface classification, time spent out of a seat, and rider input power and cadence.

9. The smart in-frame bicycle backbone of claim 1, wherein the control circuit is mounted on a circuit board attachable to a cover that snaps or locks into an opening in the top tube together with the energy harvester.

10. The smart in-frame bicycle backbone of claim 1, wherein the bicycle backbone is modular and auto‑detects components added to the bicycle frame.

11. The smart in-frame bicycle backbone of claim 1, the control circuit further comprising a GNSS receiver for determining a current location of the bicycle frame.

12. The smart in-frame bicycle backbone of claim 11, wherein the control circuit disables the GNSS receiver when location data is available from the smart device when communicatively connected with the control circuit.

13. The smart in-frame bicycle backbone of claim 1, wherein the control circuit is sized and shaped to fit into, and be retained by, a cavity formed by a top tube of a bicycle frame.

14. The smart in-frame bicycle backbone of claim 1,the energy harvester being a solar panel sized and shaped to fit into, and be retained by, a cavity formed by a top tube of a bicycle frame.

15. A method of operating a smart in‑frame bicycle backbone, comprising:
integrating a control circuit within a top tube of a bicycle frame and coupling the control circuit to a wiring bus routed within the frame;
harvesting energy from an energy harvester mounted to the top tube to power the control circuit and electronic components coupled to the wiring bus;
wirelessly communicating with at least one of a smart device and a cloud service via a wireless transceiver of the control circuit; and
executing, by the control circuit, at least one of:
(a) monitoring sensors to detect unauthorized movement and generating an alarm and alert;
(b) detecting a crash and, upon no response from a rider within a predefined period of time, transmitting a time and location to an emergency contact via the cloud service;
(c) generating usage data during rides and uploading the usage data;
(d) predicting maintenance needs based on sensed conditions and rider effort; and
(e) managing firmware for the electronic components coupled to the wiring bus.

16. The method of claim 15, wherein (c) comprises determining environmental conditions, surface type, time spent out of a seat, and power and cadence metrics.

17. The method of claim 15, wherein (d) includes using a neural network to classify noises from a microphone to detect chain wear or low tire pressure.

18. The method of claim 15, further comprising maintaining a history of usage, events, maintenance, and firmware updates as a digital passport for the bicycle.
